(19) United States
(12) Patent Application Publication
(10) Pub. No.: US 2026/0158886 A1
(43) Pub. Date: Jun. 11, 2026

(54) VEHICLE ROOF WITH MANUALLY CONFIGURABLE NESTABLE PANELS

(71) Applicant: Ford Global Technologies, LLC, Dearborn, MI (US)

(72) Inventors: Michael John Harmon, Northville, MI (US); Robert J. Gelardi, Plymouth, MI (US)

(21) Appl. No.: 18/973,250

(22) Filed: Dec. 9, 2024

(51) Int. Cl. B60J 7/11; B60J 7/19

(52) U.S. Cl. CPC B60J 7/11; B60J 7/19

(57) ABSTRACT

A motor vehicle may include a roof including a roof opening. The motor vehicle may also include a panel manually configurable between a fully closed position in which the panel covers at least a portion of the roof opening and a nested position. The panel may include a foot. Further, when the panel is in the nested position, the foot may be received in a recess of another panel.

### TECHNICAL FIELD

This disclosure relates to a motor vehicle including a roof with manually configurable nestable panels.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening; and a panel manually configurable between a fully closed position in which the panel covers at least a portion of the roof opening and a nested position, wherein the panel includes a foot, and wherein, when the panel is in the nested position, the foot is received in a recess of another panel.

In some aspects, the techniques described herein relate to a motor vehicle, wherein: the panel is a first panel, the motor vehicle further includes a second panel manually configurable between a fully closed position in which the second panel covers at least a portion of the roof opening and a nested position, and when the second panel is in the nested position, the foot of the second panel is received in a recess of the first panel or a third panel.

In some aspects, the techniques described herein relate to a motor vehicle, wherein the first and second panels are substantially identically sized and shaped.

In some aspects, the techniques described herein relate to a motor vehicle, wherein, when the first panel is in the nested position, the foot of the first panel is received in a recess of the second panel or a third panel.

In some aspects, the techniques described herein relate to a motor vehicle, wherein the third panel is rigidly mounted to the roof.

In some aspects, the techniques described herein relate to a motor vehicle, wherein, when the first panel is in the nested position, the foot of the first panel is received in a recess of the second panel or a recess in a portion of the roof.

In some aspects, the techniques described herein relate to a motor vehicle, wherein, when the first and second panels are in their respective nested positions, a foot projecting from a cross-bar is received in a recess of an uppermost one of the first and second panels.

In some aspects, the techniques described herein relate to a motor vehicle, wherein the cross-bar is connected to a roof rail of the motor vehicle.

In some aspects, the techniques described herein relate to a motor vehicle, wherein the cross-bar is able to support gear thereon.

In some aspects, the techniques described herein relate to a motor vehicle, wherein: the foot is a first foot of a plurality of feet, when the panel is in the nested position, each of the plurality of feet are received in a corresponding, respective recess of another panel.

In some aspects, the techniques described herein relate to a motor vehicle, wherein the plurality of feet consists of four feet.

In some aspects, the techniques described herein relate to a motor vehicle, wherein each of the plurality of feet is arranged adjacent a respective corner of the panel.

In some aspects, the techniques described herein relate to a motor vehicle, wherein the foot is made at least partially of rubber.

In some aspects, the techniques described herein relate to a motor vehicle, wherein: the panel includes at least one lever rotatable between a first position and a second position, when the panel is in the fully closed position and the lever is in the first position, the lever is configured to prevent movement of the panel relative to the roof, and when the panel is in the fully closed position and the lever is in the second position, the lever is configured to not interfere with movement of the panel relative to the roof.

In some aspects, the techniques described herein relate to a motor vehicle, wherein a majority of the panel by surface area is transparent.

In some aspects, the techniques described herein relate to a panel manually configured to cover and uncover at least a portion of a roof opening of a motor vehicle, including: an upper surface; a lower surface; a foot projecting downward from the lower surface, wherein the foot is tapered downwardly; and a recess adjacent the upper surface and aligned with the foot, wherein the recess is configured to receive a foot of a substantially identical panel nested relative to the panel.

In some aspects, the techniques described herein relate to a panel, wherein the foot is provided by a hollow structure, and a hollow space established by the structure provides the recess.

In some aspects, the techniques described herein relate to a panel, wherein the recess is tapered downwardly.

In some aspects, the techniques described herein relate to a method, including: manually moving a panel from a fully closed position, in which the panel covers at least a portion of a roof opening of a motor vehicle, to a nested position in which a foot of the panel is received in a recess of another panel.

In some aspects, the techniques described herein relate to a method, wherein the panel is a first panel, and further including: manually moving a second panel from a fully closed position, in which the second panel covers at least a portion of the roof opening, to a nested position in which a foot of the second panel is received in a recess of the first panel.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle, with panels arranged such that a roof opening is fully covered.

FIG. 3 is a view similar to FIG. 2, with the panels arranged in respective nested positions, and with an assembly configured to hold the panels in place, such that the roof opening is in an uncovered configuration.

FIG. 4 is a view, from an interior of the motor vehicle, of the panels in the configuration of FIG. 2.

FIG. 5 is a cross-sectional view of a portion of a panel, and in particular illustrates a first example configuration of a foot and a recess of the panel relative to a foot of another panel.

FIG. 6 is a cross-sectional view of a portion of a panel, and in particular illustrates a second example configuration of a foot and a recess of the panel.

FIG. 7 is a top perspective view of the motor vehicle with the panels arranged in respective nested positions, and with an assembly configured to hold the panels in place, such that the roof opening is in an uncovered configuration.

FIG. 8 is an exploded view of the panels relative to the assembly.

FIG. 9 illustrates an example lever.

FIG. 10 is a view similar to FIG. 2, with a first panel nested relative to a third panel.

FIG. 11 is a view similar to FIG. 10, with the first panel nested relative to the third panel, and with a second panel nested relative to the first panel.

FIG. 12 is a view of the panels and assembly of FIG. 3, with the assembly providing a portion of a roof rack.

### DETAILED DESCRIPTION

This disclosure relates to a motor vehicle including a roof with manually configurable nestable panels. Among other benefits, this disclosure allows a user to arrange the roof in a custom configuration to expose a desired portion of the passenger compartment to the elements. Further, the roof is configurable by hand, without the use of electrically powered equipment or tools.

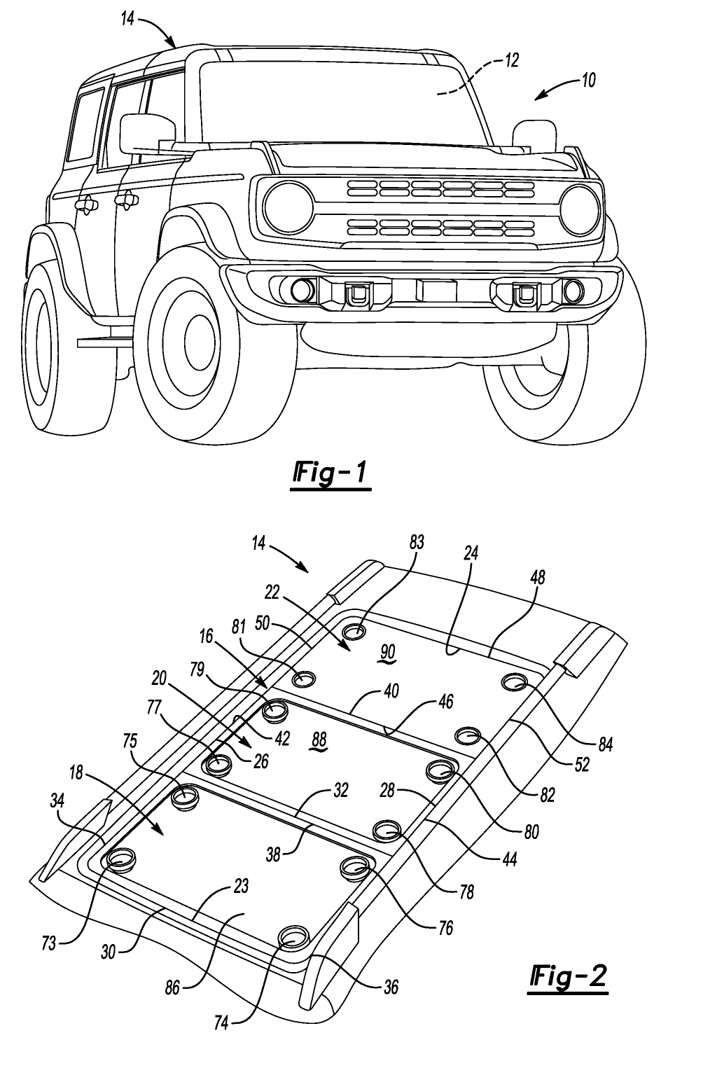

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

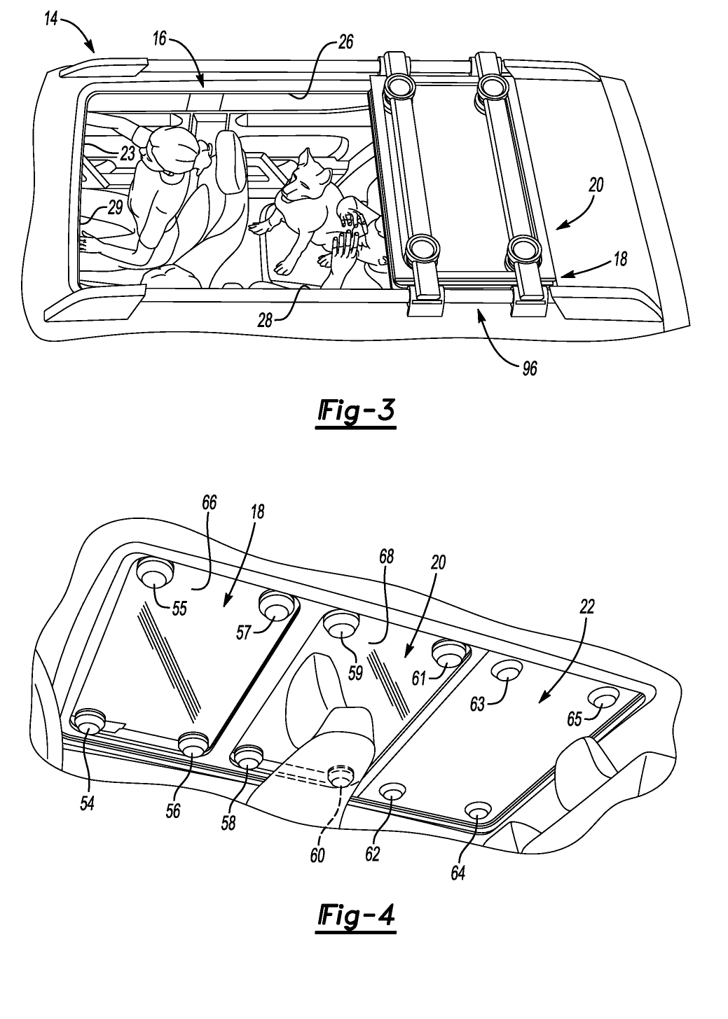

With reference to FIG. 2, the roof 14 includes a roof opening 16. The roof opening 16 is fully covered by first, second, and third panels 18, 20, 22 in FIG. 2. At least one of the panels 18, 20, 22 is manually configurable to a position in which those panel(s) do not cover at least a portion of the roof opening 16. An example configuration in which the panels 18, 20 have been manually configured into such a position is shown in FIG. 3. In FIG. 2, the panels 18, 20, 22 are arranged such that the roof opening 16 is fully covered, meaning that together, the panels 18, 20, 22 fully cover the entire roof opening 16. In FIG. 3, the panels 18, 20 are arranged such that the roof opening 16 is in an uncovered configuration. As will be explained below, the panels 18, 20 are nestable and stackable with the panel 22.

The roof opening 16 is defined between a first end 23, a second end 24 opposite the first end 23, a first side 26 extending between the first and second ends 23, 24, and a second side 28 opposite the first side 26 and extending between the first and second ends 23, 24. The roof opening 16 is substantially rectangular in this example. The roof opening 16 exhibits an area within a range of 65-85% of the area of the roof 14 (inclusive of the roof opening 16). An elastomeric seal 29 (FIG. 3) may extend about the entire perimeter of the roof opening 16. When the panels 18, 20, 22 are configured as in FIG. 2, the panels 18, 20, 22 may be held in contact with the elastomeric seal 29 to resist ingress of water, dirt, etc., relative to the passenger compartment 12.

In this disclosure, at least one panel is manually configurable between a fully closed position and a nested position in which the at least one panel nests relative to another one of the panels. When a particular panel is in the nested relative to another panel, that panel uncovers at least a portion of the roof opening 16. The at least one panel is also stackable relative to another panel, and an assembly is able to hold the stack relative to the roof 14 such that the stack of panels can be held in place on the vehicle 10 while the roof opening 16 is uncovered.

In the embodiment of FIG. 2, the vehicle 10 includes first panel 18, second panel 20, and third panel 22. The first and second panels 18, 20 are manually configurable between the fully closed position of FIG. 2, and the nested positions shown in FIG. 3. In this example, third panel 22 is rigidly mounted to the roof 14 and is not manually configurable. Reference to the panels 18, 20 being manually configurable means the panels 18, 20 are able to be configured between the fully closed and nested positions without powered electrical components, such as motors, drives, actuators, etc., and further refers to the panels 18, 20 being configurable by a user by hand and without the use of tools such as screwdrivers, drills, wrenches, etc. The third panel 22 could be rigidly attached to the roof 14 using fasteners, for example, or may be integrally formed with the roof 14 (i.e., a portion of the roof 14 establishes the third panel 22), in some examples. While two manually configurable panels are shown and described, this disclosure extends to embodiments with one or more manually configurable panels.

With reference to the configuration of FIG. 2, the first panel 18 is arranged forward of the second panel 20, and the second panel is arranged forward of the third panel 22. The “forward” direction is used herein with reference to a normal orientation of a motor vehicle. The first panel 18 includes a first end 30, a second end 32 opposite the first end 30, a first side 34 extending between the first and second ends 30, 32, and a second side 36 opposite the first side 34 and extending between the first and second ends 30, 32. In this example, a majority of a surface area of the panel 18 is transparent. In particular, a majority of the surface area of the panel 18 is provided by glass.

The second panel 20 includes a first end 38, a second end 40 opposite the first end 38, a first side 42 extending between the first and second ends 38, 40, and a second side 44 opposite the first side 42 and extending between the first and second ends 38, 40. In this example, a majority of a surface area of the panel 20 is transparent. In particular, a majority of the surface area of the panel 20 is provided by glass.

The third panel 22 includes a first end 46, a second end 48 opposite the first end 46, a first side 50 extending between the first and second ends 46, 48, and a second side 52 opposite the first side 50 and extending between the first and second ends 46, 48. In this example, a majority of a surface area of the panel 22 is transparent. In particular, a majority of the surface area of the panel 22 is provided by glass. The panel 22 may be opaque or translucent in other examples.

The first, second, and third panels 18, 20, 22 are substantially similarly-sized in this example. In particular, when the first, second, and third panels 18, 20, 22 are in the configuration of FIG. 2, the first panel 18 covers substantially one-third of the area of the roof opening 16, the second panel 20 covers substantially one-third of the area of the roof opening 16, and the third panel 22 covers substantially one-third of the area of the roof opening 16. The first, second, and third panels 18, 20, 22 may be differently-sized in other examples. There are benefits to at least the panels 18, 20 being substantially identically sized and shaped, however. In that instance, panels 18, 20 may be interchangeable, and a user may place them in any orientation (i.e., the panel 20 may be forward of panel 18). The panels 18, 20 also stack in an orderly manner when substantially identically sized and shaped.

Each of the panels 18, 20, 22 includes at least one foot, in this example. Further, the panels 18, 20, 22 each include an recess aligned with a respective foot. When the panels 18, 20 are in the nested position, the foot of a particular panel is received in a recess of another one of the panels. This arrangement serves to restrict unwanted relative movement of the panels 18, 20 when the roof opening 16 is at least partially uncovered.

In a particular example of this disclosure, each of the panels 18, 20, 22 includes a plurality of feet and corresponding recesses. With reference to FIG. 4, panel 18 includes four feet 54-57 projecting downward from a bottom (i.e., lowermost) surface 66 of panel 18 , panel 20 includes four feet 58-61 (foot 60 is not visible in FIG. 4) projecting downward from bottom surface 68 of panel 20, and panel 22 includes four feet 62-65 projecting downward from bottom surface 70 of panel 22. Feet 54-65 are arranged in respective corners of a respective one of the panels 18, 20, 22.

Each of the feet 54-65 is aligned relative to a corresponding recess. Specifically, the feet 54-65 are aligned, in a cross-car direction and a forward-backward direction, relative to a corresponding recess. With reference to FIG. 2, panel 18 includes four recesses 73-76 adjacent a top (i.e., uppermost) surface 86 of panel 18, panel 20 includes four recesses 77-80 adjacent a top surface 88 of panel 20, and panel 22 includes four recesses 81-84 adjacent a top surface 90 of panel 22.

While each panel 18, 20, 22 has four feet and corresponding recesses, this disclosure extends to embodiments in which the panels include a different quantity of feet and recesses. Further, in another embodiment, the panel 22 includes recesses but not feet.

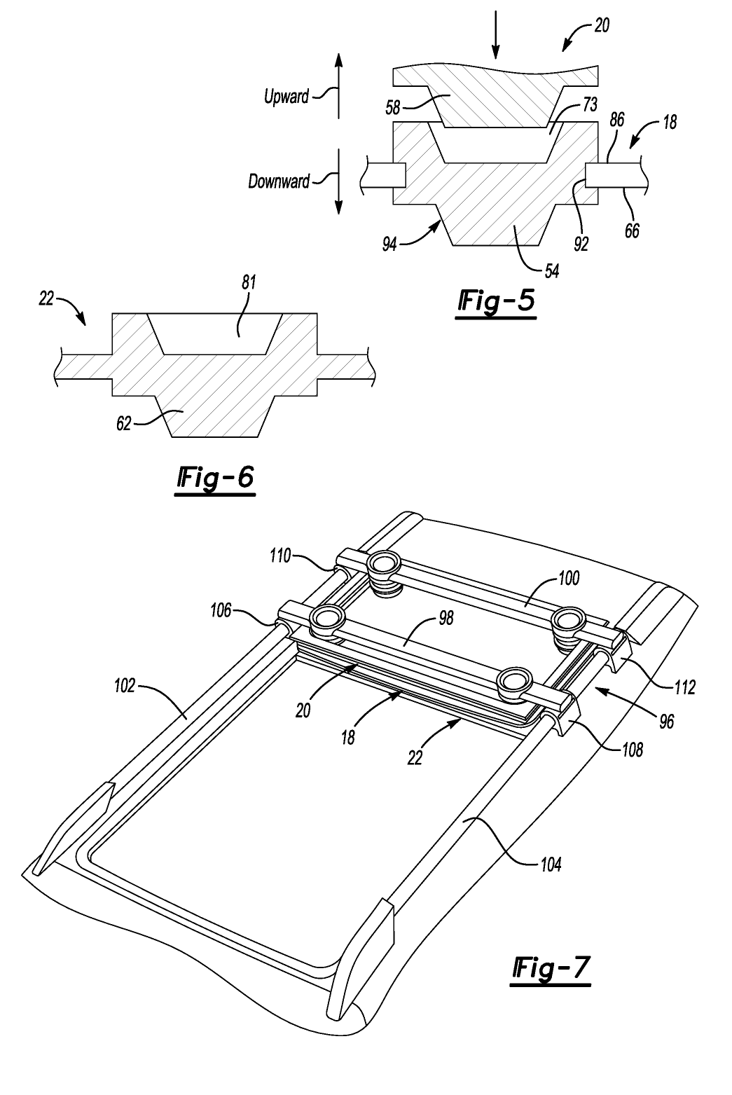

An example arrangement of the foot 54 and recess 73 relative to panel 18 is shown in FIG. 5. The panel 18 includes an opening 92 configured to interface with a structure 94 providing both the foot 54 and the recess 72. Foot 54 is tapered downwardly (the “downward” and “upward” directions are labeled for reference), meaning the diameter of the foot 54 gradually reduces moving downward. The tapered configuration of foot 54 means the foot 54 is able to be received in recesses sized and shaped similar to, or substantially identical to, recess 73. Recess 73 also exhibits a downwardly-tapered diameter. Adjacent a top of the recess 73, the recess 73 exhibits a diameter greater than a diameter adjacent a bottom of foot 54, such that the recess 73 can at least partially receive a foot sized and shaped substantially similar to, or substantially identical to, foot 54.

Foot 54 and recesses 73 exhibit substantially circular-shapes in cross-section (i.e., with sections taken into the page, relative to FIG. 5), in this example. Feet 54 and recess 73 could exhibit different shapes in other embodiments.

The structure 94 may be made partially or completely out of an elastomeric material such as rubber. The structure 94 may be integrally formed with the panel 18 in some examples. The structure 94 may be overmolded relative to the remainder of panel 18. In FIG. 5, the structure 94 is at least partially hollow, such that the structure exhibits a hollow space generally vertically above the foot 54 that establishes the recess 73. While the foot 54 and recess 73 are provided by a common structure 94, the foot 54 could be provided by a first structure projecting downward from surface 66, and the recess 73 could be provided by another, independent structure projecting upward from surface 86. In that example, opening 92 may not be necessary.

While foot 54 and recess 73 have been shown and described, feet 55-65 and recesses 74-84 are configured substantially similarly, and in particular are substantially identically sized and shaped, to facilitate nestability of the panels 18, 20, 22. In FIG. 5, panel 20 is shown nesting relative to panel 18, with foot 58 entering into recess 73 as panel 20 moves downward relative to panel 18.

With respect to the panel 22, it may be integrally formed with feet and recesses, without structures like structure 94. For instance, as shown in FIG. 6, panel 22 is integrally formed with foot 62 and recess 81. The panel 22 may be likewise integrally formed with feet 63-65 and recesses 82-84. Alternatively, the panel 22 may include feet and recesses configured as foot 54 and recess 73 in in FIG. 5.

An example assembly 96 is configured to hold the panels 18, 20 in place when the panels 18, 20 are stacked and nested relative to one another and relative to panel 22, as shown in FIG. 7. The assembly 96 includes a first cross-bar 98 and a second cross-bar 100. The first and second cross-bars 98, 100 extend between roof rails 102, 104 and are configured to clamp relative to the roof rails 102, 104 via clamps 106, 108, 110, 112 provided adjacent respective ends thereof. The clamps 106, 108, 110, 112 are configured to clamp to the roof rails 102, 104 via hand-operated clamping mechanisms, in an example. Roof rails 102, 104 may exhibit a cross-section configured to facilitate a connection with the clamps 106, 108, 110, 112. In an embodiment, the roof rails 102, 104 are substantially circular in cross-section.

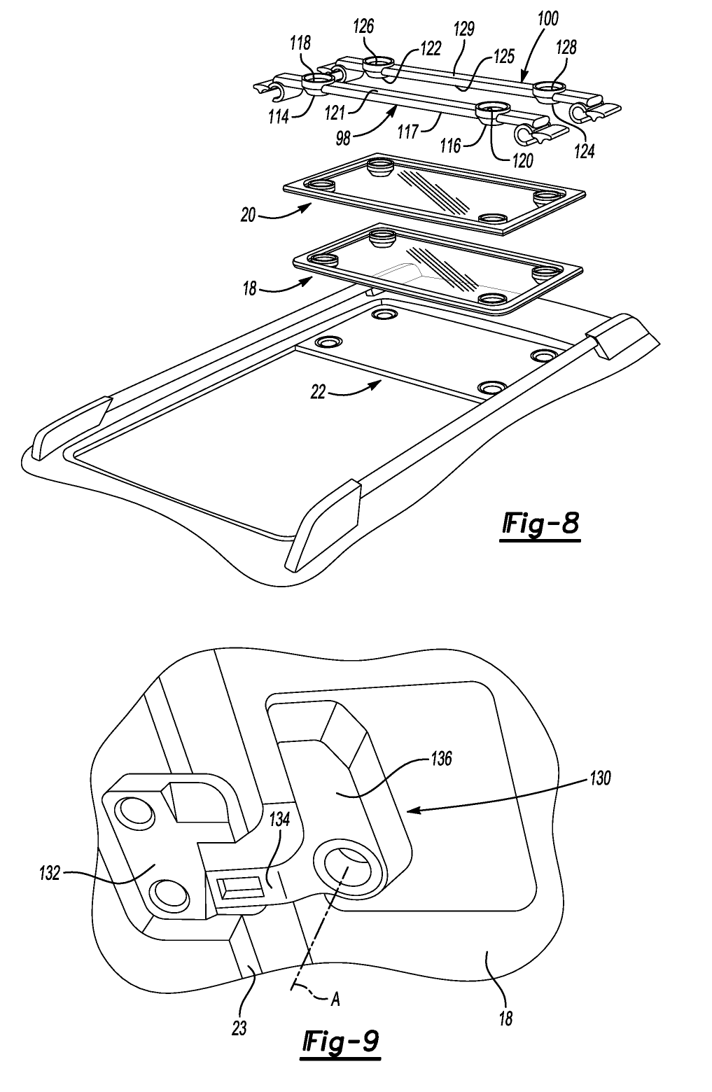

The cross-bars 98, 100 each include feet and recesses aligned with those feet. In this example, as shown in FIG. 8, the cross-bar 98 includes feet 114, 116 projecting downward from a bottom surface 117 of the cross-bar 98 and recesses 118, 120 adjacent a top surface 121 of the cross-bar 98. The cross-bar 100 includes feet 122, 124 projecting downward from a bottom surface 125 of the cross-bar 100 and recesses 126, 128 adjacent a top surface 129 of the cross-bar 100. Cross-bars 98, 100 may include elastomeric material in the locations of the feet 114, 116, 122, 124 and recesses 118, 120, 126, 128.

Feet 114, 116, 122, 124 and recesses 118, 120, 126, 128 are sized and shaped substantially identical to feet 54-65 and recesses 73-84 such that feet 114, 116, 122, 124 can be received in recesses 73-84. Recesses 118, 120, 126, 128 are not required in all examples. When present, recesses 118, 120, 126, 128 could interface with other components, such as gear, and those components/gear may themselves include feet sized to be received in the recesses 118, 120, 126, 128.

In this example, panels 18, 20 each include one or more levers configured to hold the panels 18, 20 relative to the roof 14 and/or another one of the panels 18, 20, 22. An example lever is shown with reference to FIG. 9, in which panel 18 includes a lever 130. The lever 130 is representative of the arrangement of the other levers arranged relative to panels 18, 20. Lever 130 is engaged with a portion 132 of the roof 14 adjacent end 23 in this example. Specifically, lever 130 includes a first arm 134 and a second arm 136. The first arm 134 may include a cam surface configured to engage a corresponding surface of portion 132. The second arm 136 is configured as a handle and is able to be grasped by a user. A user can grasp second arm 136 to rotate the lever 130 about axis A, such that the first arm 134 comes selectively into and out of engagement with portion 132. In the configuration of FIG. 9, the lever 130 is configured to prevent vertical movement of panel 18. When the lever 130 is rotated such that the first arm 134 does not contact the portion 132, such as when the lever 130 is rotated substantially 90° about axis A relative to configuration in FIG. 9, the lever 130 is configured to not interfere with vertical movement of the panel 18.

Lever 130 is manually rotatable, by a user by hand and without tools, to selectively engage the panel 18 with a portion of the roof 14 adjacent end 23. This disclosure extends to vehicles with a different quantity and configuration of levers. For instance, the levers could be coupled to the roof 14 as opposed to the panels.

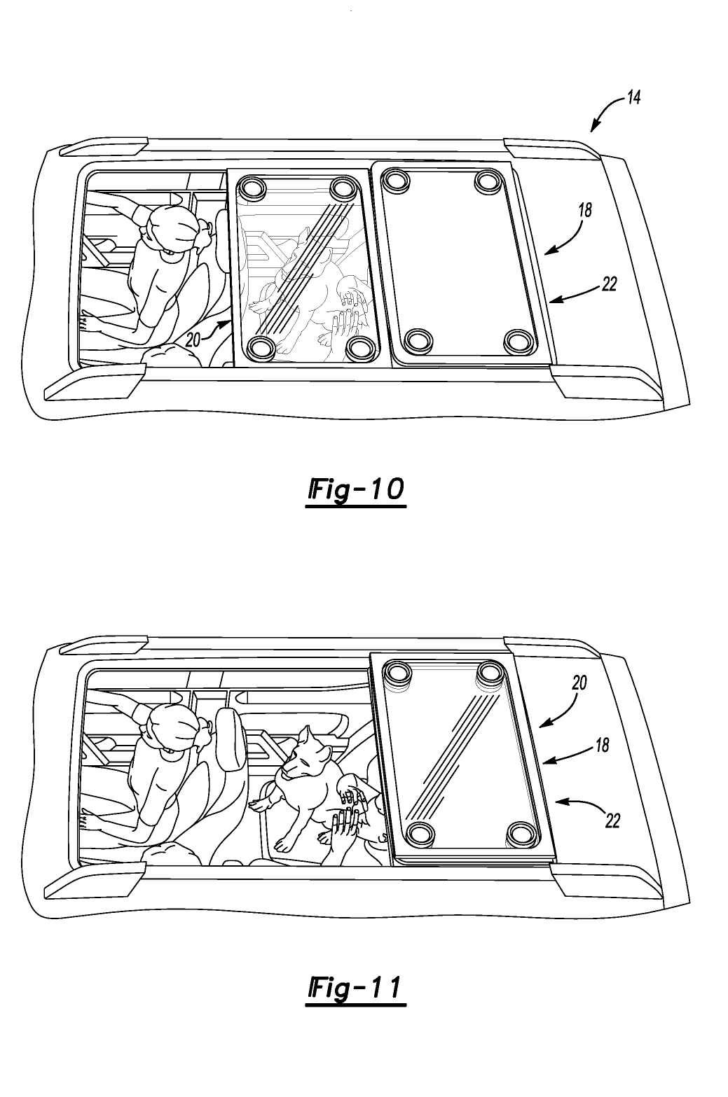

An example technique for manually configuring the panels 18, 20 will now be described. With reference to FIG. 2, with the panels 18, 20 in the fully closed position, levers holding the panel 18 in place are manually moved to a respective second position. A user then lifts panel 18 and nests the panel 18 relative to panel 22, as shown in FIG. 10. In FIG. 10, feet 54-57 are received in a corresponding one of the recesses 81-84 and the panel 18 is stacked upon panel 22. Next, levers holding the panel 20 in place are manually moved to a respective second position. A user then lifts panel 20 and nests the panel 20 relative to panel 18, as shown in FIG. 11. In FIG. 11, feet 58-61 are received in a corresponding one of the recesses 73-76. In this configuration, a user can arrange the assembly 96 such that feet 114, 116, 122, 124 are received in a corresponding one of recesses 77-80. The user can then connect the clamps 106, 108, 110, 112 relative to corresponding roof rails 102, 104 such that the assembly 96 is able to hold the panels 18, 20 in place.

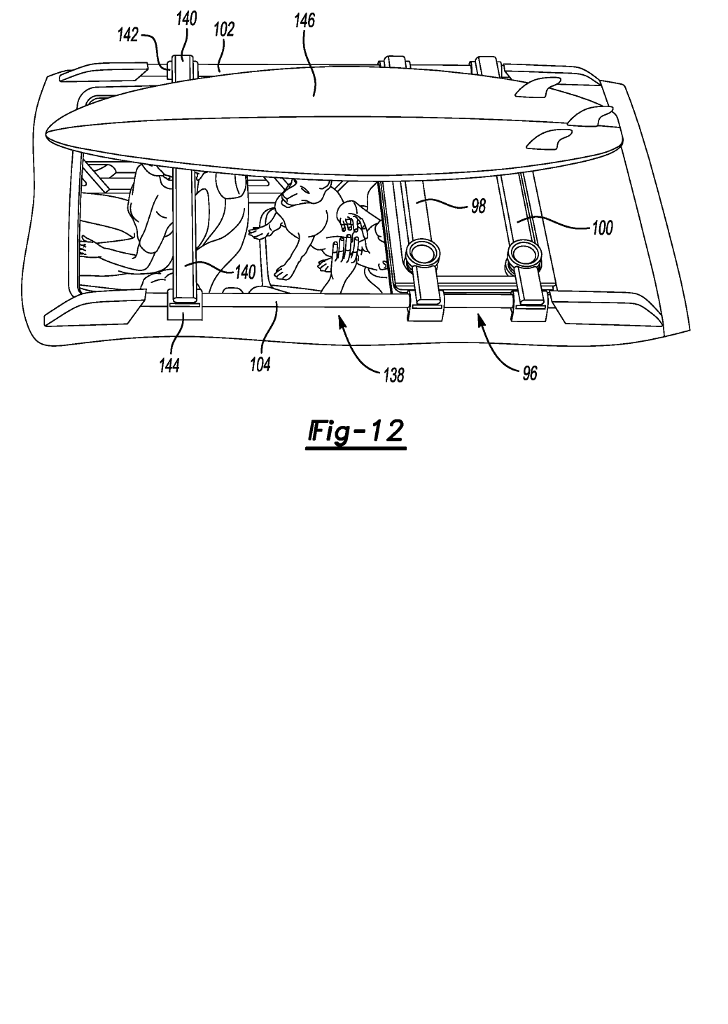

In a specific embodiment, assembly 96 provides a portion of a roof rack 138, as shown in FIG. 12. The roof rack 138 includes cross-bars 98, 100 and cross-bar 140 arranged forward of cross-bars 98, 100, in this example. Cross-bar 140 includes clamps 142, 144 configured similar to clamps 106, 108, 110, 112 and configured to manually connect to roof rails 102, 104. Cross-bars 98, 100, 140 are configured to support gear 146 thereon. Cross-bars 98, 100, 140 are substantially vertically aligned in an example. Because of the relatively low profile of the panels 18, 20, the panels 18, 20 can be held by assembly 96 without interfering with the functionality of the roof rack 138, even when the roof rack 138 supports gear 146 vertically overlapping the roof opening 16.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” “top,” “bottom,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening; and
a panel manually configurable between a fully closed position in which the panel covers at least a portion of the roof opening and a nested position, wherein the panel includes a foot, and wherein, when the panel is in the nested position, the foot is received in a recess of another panel.

2. The motor vehicle as recited in claim 1, wherein:
the panel is a first panel,
the motor vehicle further includes a second panel manually configurable between a fully closed position in which the second panel covers at least a portion of the roof opening and a nested position, and
when the second panel is in the nested position, the foot of the second panel is received in a recess of the first panel or a third panel.

3. The motor vehicle as recited in claim 2, wherein the first and second panels are substantially identically sized and shaped.

4. The motor vehicle as recited in claim 2, wherein, when the first panel is in the nested position, the foot of the first panel is received in a recess of the second panel or a third panel.

5. The motor vehicle as recited in claim 4, wherein the third panel is rigidly mounted to the roof.

6. The motor vehicle as recited in claim 2, wherein, when the first panel is in the nested position, the foot of the first panel is received in a recess of the second panel or a recess in a portion of the roof.

7. The motor vehicle as recited in claim 3, wherein, when the first and second panels are in their respective nested positions, a foot projecting from a cross-bar is received in a recess of an uppermost one of the first and second panels.

8. The motor vehicle as recited in claim 7, wherein the cross-bar is connected to a roof rail of the motor vehicle.

9. The motor vehicle as recited in claim 8, wherein the cross-bar is able to support gear thereon.

10. The motor vehicle as recited in claim 1, wherein:
the foot is a first foot of a plurality of feet,
when the panel is in the nested position, each of the plurality of feet are received in a corresponding, respective recess of another panel.

11. The motor vehicle as recited in claim 10, wherein the plurality of feet consists of four feet.

12. The motor vehicle as recited in claim 11, wherein each of the plurality of feet is arranged adjacent a respective corner of the panel.

13. The motor vehicle as recited in claim 1, wherein the foot is made at least partially of rubber.

14. The motor vehicle as recited in claim 1, wherein:
the panel includes at least one lever rotatable between a first position and a second position,
when the panel is in the fully closed position and the lever is in the first position, the lever is configured to prevent movement of the panel relative to the roof, and
when the panel is in the fully closed position and the lever is in the second position, the lever is configured to not interfere with movement of the panel relative to the roof.

15. The motor vehicle as recited in claim 1, wherein a majority of the panel by surface area is transparent.

16. A panel manually configured to cover and uncover at least a portion of a roof opening of a motor vehicle, comprising:
an upper surface;
a lower surface;
a foot projecting downward from the lower surface, wherein the foot is tapered downwardly; and
a recess adjacent the upper surface and aligned with the foot, wherein the recess is configured to receive a foot of a substantially identical panel nested relative to the panel.

17. The panel as recited in claim 16, wherein the foot is provided by a hollow structure, and a hollow space established by the structure provides the recess.

18. The panel as recited in claim 16, wherein the recess is tapered downwardly.

19. A method, comprising:
manually moving a panel from a fully closed position, in which the panel covers at least a portion of a roof opening of a motor vehicle, to a nested position in which a foot of the panel is received in a recess of another panel.

20. The method as recited in claim 19, wherein the panel is a first panel, and further comprising:
manually moving a second panel from a fully closed position, in which the second panel covers at least a portion of the roof opening, to a nested position in which a foot of the second panel is received in a recess of the first panel.
